(19) United States
(12) Patent Application Publication
(10) Pub. No.: US 2025/0062554 A1
(43) Pub. Date: Feb. 20, 2025

(54) Fish-Eye Terminal Structure

(71) Applicant: CHUN-JUI CHEN, TAINAN (TW)

(72) Inventor: CHUN-JUI CHEN, TAINAN (TW)

(21) Appl. No.: 18/611,373

(22) Filed: Mar. 20, 2024

(30) Foreign Application Priority Data
Aug. 18, 2023 (CN) 2023222317437

(51) Int. Cl. H01R 12/58

(52) U.S. Cl. CPC H01R 12/585

(57) ABSTRACT

This disclosure pertaining to the technical field of electrical connector structures, specifically relates to an electrical connector structure of a fish-eye terminal. It comprises an insertion part and a connecting part, with the insertion part further comprising a guiding section, an inserting section, and a connecting section. The guiding section is flat and arc-shaped, and the insertion part is connected to the connecting part through the connecting section to form an integral whole. The guiding section, inserting section, and connecting section are integrally formed, presenting a shuttle-like structure with two smaller ends and a larger middle. The lower part of the inserting section is integrally formed with its both ends connecting to the guiding section and the connecting section respectively. The upper part of the inserting section is olive-shaped and disposed with a groove, with an enhanced edge disposed on the outer side of the groove. This utility model, by changing the original design of the internal hole of the fish-eye terminal to a groove structure, where the groove structure deforms, significantly enhances the deformation resistance of the fish-eye terminal, thereby improving the connection strength.

### CROSS REFERENCE TO RELATED APPLICATION

The present application claims priority to CN patent application Ser. No. 2023222317437, filed on Aug. 18, 2023, which is hereby incorporated by reference in their entirety.

### FIELD

This disclosure relates to the field of electrical connectors, specifically to an electrical connector structure of a fish-eye terminal.

### BACKGROUND

Currently, the conventional method of connecting PCB (Printed Circuit Board) boards and conductive terminals is through soldering. However, due to the poor environmental resistance of soldering, which leads to easy oxidation and poor vibration resistance, the life expectancy is significantly reduced. Therefore, in products with high requirements for quality and lifespan, electrical connections between different PCB boards or between PCB boards and other electronic components are achieved through fish-eye terminals. When in use, the fish-eye terminal is inserted into the through-hole of the PCB board. The presence of a hole inside the fish-eye terminal allows it to undergo elastic deformation, thereby achieving a tight fit with the through-hole in the PCB board. Utilizing fish-eye terminals for electrical connections offers a certain level of universality and interchangeability, meaning the same fish-eye terminal can be used for different PCB boards. Compared to soldered connections, fish-eye terminal connections do not involve a soldering process, making them more environmentally friendly, with a longer service life and higher connection strength. However, fish-eye terminals are precision components that require high standards in shape and structural design. For example, in the Chinese utility model U.S. Pat. No. 20021922424.0 titled “A Fish-eye Terminal”, a similar structure is proposed. During use, due to the presence of a hole inside the fish-eye terminal, it contracts inward when compressed. Despite its ability to rebound, it is difficult to return to its original shape, leading to issues with the fish-eye terminal not fitting tightly in the through-hole, as well as insufficient universality of the fish-eye terminal for interchangeable use with different PCB boards.

### SUMMARY OF THE DISCLOSURE

The objective of this utility is to overcome the deficiencies of the existing technology by providing a fish-eye terminal structure that allows for compact insertion, good electrical connectivity, and resistance to external environmental impacts.

The technical solution adopted in this utility is as follows:

A fish-eye terminal structure consists of an insertion part and a connecting part. The insertion part includes a guiding section, an inserting section, and a connecting section. The guiding section is flat and arc-shaped, and the insertion part is connected to the connecting part through the connecting section to form an integral whole. The guiding section, inserting section, and connecting section are integrally formed, presenting a shuttle-like structure with two smaller ends and a larger middle. The lower part of the inserting section is integrally formed with its both ends connecting to the guiding section and the connecting section respectively. The upper part of the inserting section is olive-shaped, disposed with a groove, and an enhanced edge is disposed on the outer side of the groove.

In some embodiments, the width of the lower of the inserting section is less than the width of the upper of the inserting section.

In some embodiments, the groove of the inserting section is disposed on the upper of the inserting section;

In some embodiments, the enhanced edge on the outer side of the groove is integrally formed with the inserting section.

In some embodiments, the groove on the upper of the inserting section and the upper contoured shape of the inserting section.

In some embodiments, the end of the guiding section is smoothly arc-shaped, with its maximum width section being less than or equal to the minimum width section of the inserting section.

In some embodiments, the maximum width section of the connecting section is less than or equal to the minimum width section of the inserting section

Due to the modification of the original design of the fish-eye terminal's internal hole to a groove, where the groove deforms significantly enhances the deformation resistance of the fish-eye terminal, thereby improving the connection strength.

### BRIEF DESCRIPTION OF THE DRAWINGS

FIG. 1 is a perspective view of this disclosure;

FIG. 2 is a front view of this disclosure;

FIG. 3 is a rear view of this disclosure;

FIG. 4 is a top view of this disclosure;

FIG. 5 is a side view of this disclosure;

FIG. 6 is an enlarged view of FIG. 1.

### DETAILED DESCRIPTION

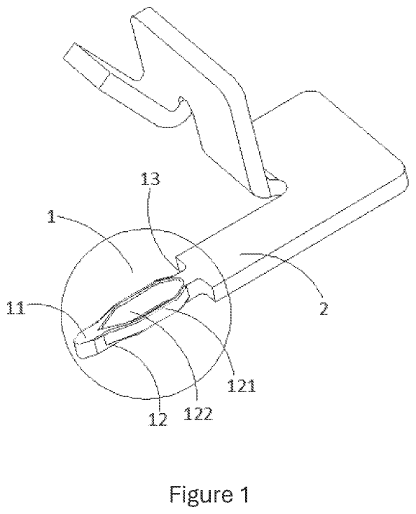

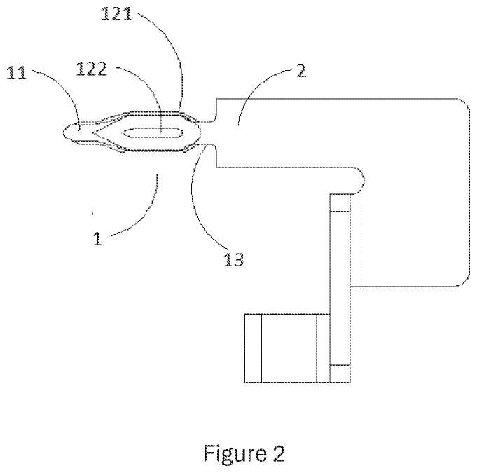

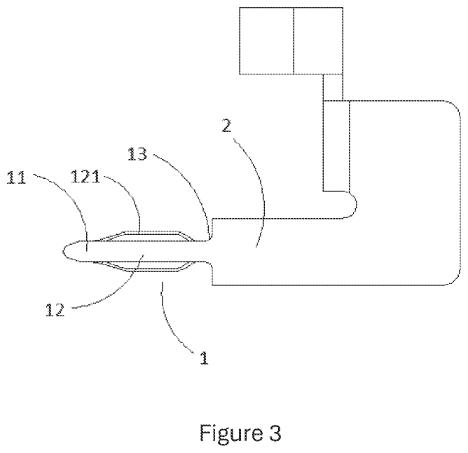

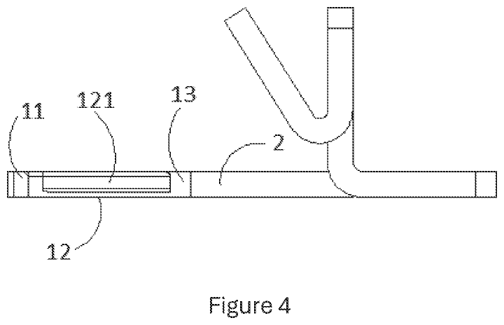

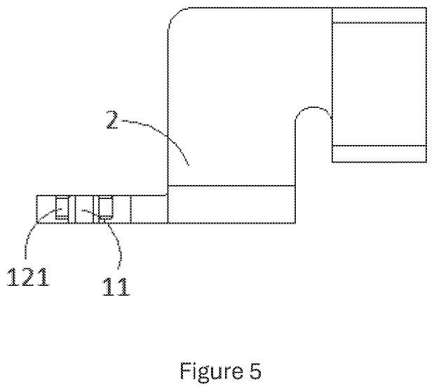

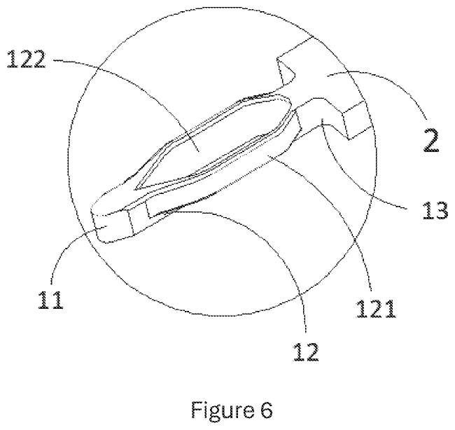

Referencing FIGS. 1 to 6, the fish-eye terminal structure consists of an insertion part 1 and a connecting part 2. The insertion part 1 includes a guiding section 11, an inserting section 12, and a connecting section 13. The guiding section 11 is flat and arc-shaped. The insertion part 1 is connected to the connecting part 2 through the connecting section 13 to form an integral whole. The guiding section 11, inserting section 12, and connecting section 13 are integrally formed, presenting a shuttle-like structure with two smaller ends and a larger middle. The lower part of the inserting section 12 is integrally formed with its both ends connecting to the guiding section 11 and the connecting section 13 respectively. The upper part of the inserting section 12 is olive-shaped and disposed with a groove 122, with an enhanced edge 121 disposed on the outer side of the groove 122.

The width of the lower part of the inserting section 12 is less than the width of the upper of the inserting section 12.

The groove 122 of the inserting section 12 is disposed on the upper of the inserting section 12.

The enhanced edge 121 on the outer side of the groove 122 is integrally formed with the inserting section 12.

The groove 122 on the upper of the inserting section 12 and a contoured shape of the upper of the inserting section. 12.

The end of the guiding section 11 is smoothly arc-shaped, with its maximum width section being less than or equal to the minimum width section of the inserting section 12.

The maximum width section of the connecting section 13 is less than or equal to the minimum width section of the inserting section 12.

When this utility model is applied, the operator inserts the guiding section 11 of the insertion part 1 into the through-hole of a PCB board. The guiding section 11 then leads the inserting section 12 into the through-hole of the PCB board. Since the width of the upper part of the inserting section 12 is greater than the widest point of the guiding section 11, and the groove 122 of the inserting section 12 is located at the upper part, the groove 122 is deformed under pressure, but the lower part of the inserting section 12 is solid, ensuring the rigidity of the inserting section 12. This design ensures a stronger connection process and provides an outstanding anti-shake effect.

1. A fish-eye terminal structure, consists of
an insertion part and a connecting part, the insertion part includes a guiding section, an inserting section, and a connecting section, where the guiding section is flat and arc-shaped, and the insertion part is connected to the connecting part through the connecting section to form an integral whole;
the guiding section, inserting section, and connecting section are integrally formed, presenting a shuttle-like structure with two smaller ends and a larger middle, characterized in that:
the lower part of the inserting section is integrally formed with its both ends connecting to the guiding section and the connecting section respectively;
the upper part of the inserting section is olive-shaped and disposed with a groove, with an enhanced edge disposed on the outer side of the groove.

2. The fish-eye terminal structure according to claim 1, characterized in that the width of the lower of the inserting section is less than the width of the upper of the inserting section.

3. The fish-eye terminal structure according to claim 1, characterized in that the groove of the inserting section is disposed on the upper of the inserting section.

4. The fish-eye terminal structure according to claim 1, characterized in that the enhanced edge on the outer side of the groove is integrally formed with the inserting section.

5. The fish-eye terminal structure according to claim 1, characterized in that the groove on the upper of the inserting section and a contoured shape of the upper of the inserting section.

6. The fish-eye terminal structure according to claim 1, characterized in that the end of the guiding section is smoothly arc-shaped, with its maximum width section being less than or equal to the minimum width section of the inserting section.

7. The fish-eye terminal structure according to claim 1, characterized in that the maximum width section of the connecting section is less than or equal to the minimum width section of the inserting section.
